(19) United States
(12) Patent Application Publication
(10) Pub. No.: US 2022/0198560 A1
(43) Pub. Date: Jun. 23, 2022

(54) SYSTEM AND METHOD FOR DISSEMINATION OF DATA FROM INTERACTIVE MULTI-AGENTS VENUES

(71) Applicants: Tsachi GALANOS, Tel Aviv (IL); Eyal AVIV, Tel Aviv Jaffa (IL); Sergey BONDARCHUK, Tel Aviv Jaffa (IL); VELOXPRO SOFTWARE CYPRUS LTD., LIMASSOL (CY)

(72) Inventors: Tsachi GALANOS, LIMASSOL (CY); Eyal AVIV, LIMASSOL (CY); Sergey BONDARCHUK, LIMASSOL (CY)

(21) Appl. No.: 17/283,880

(22) PCT Filed: Oct. 2, 2019
(86) PCT No.: PCT/IL2019/051080

§ 371 Date: Apr. 8, 2021

(30) Foreign Application Priority Data
Oct. 4, 2018 (IL) 262155

(51) Int. Cl. G06Q 40/04

(52) U.S. Cl. CPC G06Q 40/04

(57) ABSTRACT

Enhanced method and architecture for providing data clients with a raw data feed allowing to producing a local made copy of a world evolving state of a multiagent interactive venue. Wherein said raw data feed is the actions that being sent by agents to the venue, and Wherein said venue processing said actions according to predefined rules defining how each of said actions affects the world state of the venue, and Wherein said world state is the cumulative effect of actions of agents, applied on the initial world state.

### TECHNICAL FIELD

Embodiments of the invention relate to a system and/or effective method for dissemination of data feeds, in particular order-by-order full market depth and trading data from financial exchanges and other trading venues.

### BACKGROUND

Various types of venues exist where rules relating to the venue permit multiple users (or agents) to interact with each other within the venue and affect the state within the venue according to those rules. Such venues may include trading venues such as financial exchanges and the like. The initial state within the venue may or may not be void. For instance, the initial state within a trading venue is typically void because exchanges don't place their own orders there, but the initial state within other venues could comprise an environment before agents begin to act. The ongoing state within the venue is the cumulative effect of the actions of the agents, applied on the initial state.

In online computer venues, for example, users can interact with each other according to rules defining the set of permitted actions and how they affect the state of the venue and consequently other users.

Trading venues (“Exchange”) as a further example bring together buyers and sellers and use matching engines (“Matching Engine”) in order to execute their trading activities in stocks, bonds, futures, currencies, digital or cryptocurrencies, or the like including purely virtual assets. Trading venues include exchanges such as NASDAQ, CME, Eurex, GDAX or the like—include trading related electronic communication networks (ECN), and purely virtual non-financial and/or not profit driven trading venues.

Exchanges facilitate trading of specific products, assets or financial instruments (“Asset” or “Instrument”) by continuous processing of orders and requests entered by dealers or traders (“Trader”). An order is a set of parameters such as to buy or sell certain size/quantity of an asset (such as number of Crude Oil futures contracts) at the best available price (“Market Order”) or at a price better or equal to a specified price (“Limit Order”). Typically exchanges also allow traders to request replacement/modification of some parameters of not executed yet limit orders such as their price or size, or to request complete cancellation of such orders.

Exchanges utilize communication protocols that are a publicly available set of rules which define the set of available actions (such as sending, replacing or canceling orders), and the impact of each action on the state within the trading venue. The state within a trading venue is its Limit Order Book (“LOB”). It contains a set of resting buy and sell limit orders which have limit prices that prevent their immediate matching/execution. The top of the LOB consists of sell orders with lowest price and buy orders with highest price and a spread between them. Top of the LOB tells traders at which price incoming buy and sell orders can be matched instantly. Matching algorithm (“Matching Algorithm”) is a part of the rules. It describes how matching engine processes incoming orders and requests including the priority in which they are matched against resting orders in LOB.

For interaction between multiple users to successfully take place, users typically require a feedback as to the evolving state within the venue in general so that their actions can be more intelligent and relevant to the evolving environment (“World”), which is typically competitive. For example, in a computer online auction, buyers wish to be provided with most recent and most accurate offers, bids and actions of other buyers or seelers before acting or deciding how to act. Similarly, traders are typically interested in such feedback from the exchange in the form of market data upon subscription.

Such feedback is provided by data feed, which must be sufficient for the data subscribers to be aware of most recent state of the world and to track its changes. Ideally, data subscribers want it to be as transparent as possible. Due to interactions and quick reactions of agents on major actions of other agents, such stream of data can be extremely not uniform in terms of amount of data per unit of time and frequently may appear in bursts of network traffic. For instance, a single action of an agent may cause numerous changes in the environment at once, when a single large order being matched against many small orders on multiple price levels. Such bursts of activity in the data stream may cause latencies in arrival of the data to agents and consequently harm their experience and effectiveness of interaction. Therefore it's highly desirable for the feedback to be as compact as possible, allowing lower requirements for minimum network bandwidth, and thus allowing more agents/users to participate in the interaction.

### SUMMARY

The following embodiments and aspects thereof are described and illustrated in conjunction with systems, tools and methods which are meant to be exemplary and illustrative, not limiting in scope.

Various embodiments of the invention relate to systems where: 1) Multiple agents interact through a venue by sending their actions either synchronously or asynchronously; 2) The combination of incoming actions from all agents is synchronized at the venue into a stream of actions (“SOA”); 3) The venue contains a dynamic environment, a world, which is the cumulative effect of the SOA, applied on its initial state (whether it is void or not); 4) The venue comprises set of rules, which unambiguously determine the set of valid actions and how each action affects the world; 5) The rules are publicly available to agents.

The invention describes a more effective (and in some embodiments such as trading venues—the most effective possible) architecture and method by which data from the venue can be disseminated to the agents.

The invention suggests to disseminate the data to agents in the form of SOA, which allows each agent to form its local copy of the world, keep it up to date, and track its dynamics.

The proof of concept of such solution can be demonstrated both in practice and logically: processing of identical data with identical rules must produce identical results.

Various embodiments of the invention include systems described in #010 including online venues housing interactive learning, auctions, and online trading (etc.).

An aspect of at least certain embodiments of the invention relates to a method of market data dissemination from trading venues such as trading stocks, bonds, futures, currencies, digital or cryptocurrencies, or the like including purely virtual assets.

Such method system and/or architecture in at least certain embodiments, specifically trading venues such as financial exchanges, can function to disseminate market data in the form of SOA, which has important advantages over currently used methods.

Trading venues match the system description and criteria in #010 as following: 1) Multiple traders interact through the exchange by sending, canceling and replacing their orders in an asynchronous manner; 2) The combination of incoming actions from all traders is synchronized at the exchange; 3) The exchange contains a dynamic environment in the form of LOB which is the cumulative result of the actions of traders; 4) The exchange comprises a set of rules, which unambiguously determine the set of valid actions of traders, and the matching algorithm; 5) The rules are publicly available to traders.

A typical list of valid and available for traders actions is to send a new order (“Send”), and to request to modify/replace (“Replace”) or cancel (“Cancel”) a resting, unexecuted yet order. Hence, the SOA in embodiments related to trading venues can be named SRC. As part of the rules, matching algorithm determines the processing algorithm of any valid incoming actions given any state of the LOB.

Many methods of market data dissemination exist. Typically they use various formats of data updates to inform data clients about executions, and to instruct them how to update their local copy of LOB. In comparison to the SRC method at least one of the following statements is true: 1) Other methods are less transparent and provide less information about LOB state or events that occur in it or the causes of these events; 2) Other methods are less compact, produce higher bursts in network traffic, and therefore have higher minimum bandwidth requirement for the agents to handle the data; 3) Other methods have higher latency from the trading venue to the agents.

A logical proof for the first statement in #019 is this: it's possible to convert SRC data into any other existing or hypothetical type of data without loss of information, but the opposite is false. Theoretically, it may be possible to convert sequences of events in some modern types of market data such as order-by-order or market-by-order (“MBO”) into SRC using specifically developed algorithms and knowledge on how their market data is generated. But being “undocumented” by the exchange, i.e. different from how the data updates should be processed locally, this approach does not guarantee reliability of the result.

A logical proof for the second statement is this: any single data event of any other non-aggregated type of data can be presented by no more than a single event of SRC data, but the opposite is false. An example of such situation is arrival of a large order that is being matched against many smaller resting orders in LOB. Such information can be provided to data subscribers using a single “S” event of SRC, for instance, a market order: Side=Buy, Quantity=1000, Limit price=None. However, other types of data including the types used by major exchanges such as CME, Eurex, Nasdaq, would transmit a series of data events in the same situation. Large orders are frequent in trading venues. In addition, major events such as large trades typically trigger instant response from many other market participants in the form of their own actions, causing bursts in the network traffic.

SRC architecture and method allow to transmit full market depth and trading data with maximum transparency without loss of information and in the most compact way possible. Traders may receive market data directly from the exchange (including exchange co-located facilities) or through a data vendor. Exchanges and data vendors may offer to traders the data in either SRC format or derive from it any other data format including those that are being used today. This is possible because deterministic matching algorithm allows to convert SRC into any other data format without loss of information.

SRC architecture and method according to certain embodiments makes use of matching engines that process the incoming actions of traders using any predefined but deterministic matching algorithm that defines how incoming actions are processed and in which priority they matched against the resting orders in the LOB when match is possible. Since identical matching algorithm is used on identical sequence of SRC actions, it produces identical result in the matching engine and on the client side of each trader or data client in general.

SRC architecture and method allow (but don't require) a more effective hardware architecture of exchanges. Typically market data is generated and released to data clients after the incoming actions are processed by the matching engine. Since processing of some actions such as large aggressive orders require more computation resources of matching engine than other actions such as order cancellation, the latency between entrance of an event into the exchange until the arrival of corresponding data to the clients may vary. SRC allows to transmit market data in the form of actions as soon as the new incoming action is validated and approved, but before it's processed by the matching engine of the exchange. This allows to reduce the latency of market data delivery to the clients and to make it more stable, i.e. uniform.

The core innovation of SRC method and its core difference from other types of data feed is this: Other types of data feed consist of various forms of information that tells data clients about trades/executions and instructs data clients how they must update their local copy of the environment (the world) to achieve some (full or partial) view of the original LOB in the matching engine. Instead, SRC consists only of raw actions of market participants.

SRC method is neutral to specific rules which are the set of valid actions and the matching algorithm as long as the rules are deterministic and public. In fact a variety of matching algorithms can be used by the same exchange for different assets/instruments. For instance, here is an overview of various matching algorithms used by CME followed by their detailed description: https://www.cmegroup.com/education/matching-algorithm-overview.html.

Matching algorithm is a part of public information about instrument/asset specifications.

Being neutral to specific rules, SRC innovation does not include specific software or hardware implementations of matching engine on the client side. First, because the variety of existing matching algorithms is large and the variety of hypothetical matching algorithms is virtually unlimited. Second, because the goal of data clients may be different including situations where implementation of matching engine is unnecessary, such as pure recording of the data for further use or tracking extraordinary orders or patterns (and the like). In practice, exchanges and 3rd parties may offer to data clients their own implementation of matching algorithms in a form of software or hardware. In addition, trading communities may develop such implementations as open source and/or conduct contests for best implementation.

It's true that SRC method puts the responsibility of matching engine on the data clients. However, it doesn't necessarily mean higher complexity of data processing or higher demand for computation power on the client side. Other types of data feed such as market-by-price (MBP) or market-by-order (MBO) also require to apply data updates on the local copy of LOB on client side according to order book management algorithm, specific for each data type such as data management algorithm of CME MBO data (https://www.cmegroup.com/confluence/display/EPICSANDBOX/MDP+3.0+−+Market+by+Order+−+Management) or Nasdaq TotalView data (http://www.nasdaqtrader.com/content/technicalsupport/specifications/dataproducts/NQTVITCHSpecification.pdf). Such algorithms may have similar or even higher complexity than corresponding matching algorithm such as regular FIFO (https://www.cmegroup.com/confluence/display/EPICSANDBOX/Matching+Algorithms#MatchingAlgorithms-FIFO), also called Price-Time priority matching algorithm.

SRC method requires data events to be processed in exactly the same order/sequence as the synchronized stream of actions, processed by the exchange. This requirement is not different from other types of incremental data feed such as MBP, MBO, Nasdaq TotalView and others where updates of market data must be processed in the provided order/sequence. Typically this is achieved by attaching an ascending sequence ID to incremental data updates before publishing them. This also allows such types of data feed to offer a recovery mechanism which can be used by data clients for late connection or after a disconnection or broken sequence of data updates. Such mechanisms allow to rebuild a local copy of LOB and continue receiving real-time updates. A very similar mechanism can be used for late connection or for recovery within SRC data which consists of incremental data updates in the form of actions. The initial state of the LOB can be provided by a series of Send (“S”) updates only.

Being most transparent/informative and most compact at the same time, SRC method of data dissemination may be useful for a variety of data clients, such as market data vendors for either retail or professional clients, direct data feed clients, high-frequency and algorithmic trading firms, clients who record market data for further use of historical data either for internal purposes such as algorithms development or for reselling it (and the like).

Since SRC data consists of pure/raw actions of traders and not of derivatives of it, it is a good choice for research and education purposes including studies of market dynamics and microstructure, game theory, social behaviour (and the like). It also opens an easier path for research and development of trading bots which mimic the behaviour of other, either human or algorithmic traders, and/or compete with them.

Agents may or may not perform actions at any time, asynchronously from other agents. Agents may or may not use various sources of information available to them, including the data feed. For instance, some agents may only be interested in recording the data without sending actions and participating in the interaction. Some other agents may send actions blindly, without subscribing and/or processing any data. For instance, a trader could keep sending actions without checking the evolving state of the world, some of which may be valid actions.

The innovation/SOA/SRC method of data dissemination does not restrict systems from supporting more complex actions, for instance, conditional actions. For example, exchanges typically allow traders to send stop orders (“Stop Order”) which contains a parameter called trigger price. Matching engines do not process such orders before a trade/match of any other order occurs at a price equal or worse than the trigger price of such stop order. Another example is iceberg orders (“Iceberg Order”). Iceberg orders contain a “maximum displayed size” parameter, typically significantly lower than the total size of the order. This instructs the exchange not to display in the LOB more than specified. Other examples of conditional orders include chains of orders such as Order-Sends-Order, or time-in-force (“TIF”) parameter of orders which tells the exchange during which period of time the trader permits to process the order, or the like. In general, exchange may contain the visible part of the world in the form of LOB and the invisible part as shown here: https://bookmap.com/wiki/Market_Mechanics#Order_Book. Although SRC method provides the full view of LOB and its dynamics, like any other method, it can provide only the visible part of it. None of other data feed types provide the view of the invisible part either.

In many systems actions arriving to the exchange may contain information for the purpose of authentication of agents and validation of their actions (e.g. account balance) before processing the action. Depending on the exchange or specific embodiment, such information may be either removed from the actions or replaced by an anonymous but unique agent ID (or the like) without affecting the consistency of SOA/SRC data feed.

Thus, the SRC (SOA in general) solution according to at least certain embodiments of the invention may embody at least some of the following advantages.

Better transparency: the actions of all agents can be converted into any other stream of instructions of how to update the world's state, but not vice versa.

Higher compression: lower bandwidth requirements for agents to handle the stream of actions compared to handling other types of data. For example, in at least some embodiments it's common that a single action may cause multiple changes in the world's state, producing a series of updates and instructions as to how to update the “world” state. In at least some embodiments such as trading or gaming such series can consist of hundreds or thousands of items. In comparison, the SOA method transmits this information as a single event that describes the action itself.

Lower latency: SOA can be transmitted to data clients before applying it on the world within the venue, not after.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The detailed description of systems to which the invention is applicable is given in #010. The invention, however, both as to organization and method of operation, together with objects, features, and advantages thereof, may best be understood by reference to the following detailed description when read with the accompanying figures, in which:

FIG. 1 schematically illustrates the description of systems to which the innovation is applicable, and the innovation itself.

FIG. 2 schematically illustrates trading venues as one of the embodiments of the innovation.

FIG. 3A schematically illustrates the structure of a typical Order Book.

FIG. 3B schematically illustrates actions of traders and how they are processed by Matching Engine using as an example Price-Time priority Matching Algorithm. FIG. 3B also illustrates how different types of market data feed provide this information to data clients, and demonstrates the advantages of data feed in the form of SRC.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

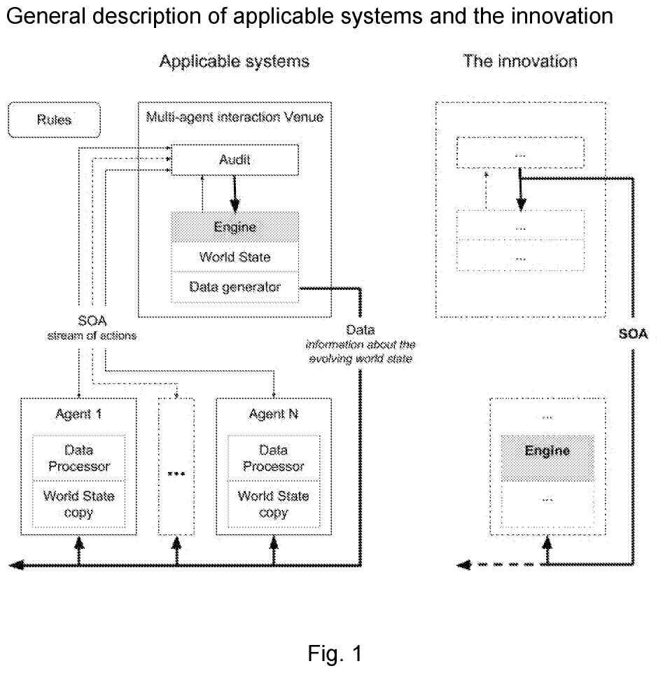

Attention is drawn to FIG. 1 illustrating a venue in which multiple agents (from #1 to #N) may interact. Agents according to various embodiments of the invention may send various actions into the venue via an individual connection and may receive feedback via the same or similar individual connection. Such individual feedback may include confirmation or rejection of agent's actions, ongoing updates about agent's pending actions such as partial execution of a limit order, and the like.

The rules describe the set of available to agents actions and how each action affects the world state—the state within the venue. The location of rules component outside the venue demonstrates that rules publicly available at least to the agents. Also, it demonstrates that rules are relatively static, i.e. don't change frequently. The rules are identically available to the agents, but may describe not identical effect of actions of different types of agents. For instance trading venues may offer privileges for registered Market Makers. In such cases the type of the agent becomes part of the action, making the processing of the actions deterministic according to the rules.

Agents may act asynchronously from different locations and may have different latency to the venue. Any two consequent actions may produce different effect if processed in a different order. Therefore the actions of agents are synchronized into a single stream of actions (synchronized SOA), typically according to the order of their arrival to the venue.

The audit component represents various preprocessing mechanism of the incoming actions. It includes synchronization, validation or rejecting of actions, reporting on the status of pending actions via the individual connection (e.g. about partially executed limit order) and the like. Audit may remove some or all agents' personal data from their incoming actions (such data may be required for authorization of the agent) or replace it by anonymous ID code, and the like. Audit may also contain collection of conditional actions which do not affect the world state until certain condition occurs. In trading venues such conditional actions may include Iceberg orders, Stop orders, chains of orders, and the like.

The dotted arrow from the engine to the audit illustrates that the audit may monitor the system including the world state, e.g. for logging and recording, monitoring the conditions for the conditional actions that may depend on the world state, and the like.

The wide arrow from the audit to the engine represents synchronized and “clean” SOA in which each action must be immediately applied on the world state.

The engine processes SOA, applying the actions on the world state according to the deterministic rules described by the component called rules.

The agents and data clients in general are typically interested to receive information about the evolving world state. Agents may be able to act without subscribing to the data feed from the venue as long as their actions are valid. But typically they are interested the data to be transparent, low latency, and compact enough so they can handle the data even with low internet connection speed. Also, some agents may be interested to subscribe to the data feed without participating in the interaction. The wide arrow that points to the left illustrates that such data clients may exist.

Depending on certain embodiments and certain venues within the same embodiment, the data may be provided in different forms. Typically it contains information about events that occured within the venue and/or instructions that tell data clients how to adjust their local copy of the world state due to recent events. Data clients may process the data accordingly using a data processor. The local copy of world state doesn't necessarily mean the exact copy of the world state within the venue. Venues may allow various degree of transparency of the world state including the ability to view its identical copy (up to the latency), or a very limited view such as in case of dark pools in relation to trading venues. The same venue may offer to data clients different types of data feed for different purposes and for different cost of subscription including aggregated data or indicators and alerts derived from the data.

The innovation provides a solution for the venues that wish to offer their data clients maximum transparency and lowest latency in as compact as possible way. This allows low requirements on internet connection speed, thus more data clients can benefit from such data.

The innovation is illustrated on the right side of the FIG. 1 and highlights only the differences compared to the general system description.

The innovation is based on the fact that rules describe in deterministic way the impact of each action on the world state. Thus, applying identical processing algorithm on identical SOA within identical world state must produce identical result. The diagram shows that venues may provide the data in the form of SOA and agents may process it according to the rules using a local engine, similar to the engine within the venue. This allows agents to view an exact copy of the world state within the venue.

Another positive consequence of this solution is the ability (but not a requirement) for the venues to transmit the data immediately after the SOA is preprocessed by the audit, but before it enters the engine. This allows a more efficient architecture within the venue because the original data generator becomes unnecessary (there must be a component responsible for the dissemination of SOA, but not for generation of the data).

Since some actions may cause significantly higher impact on the world state than others, and this require more computation resources and time of computation, the latency between arrival of an action to the venue until the corresponding data is transmitted may vary. Thus, disseminating the SOA data before it enters the engine makes this latency more uniform. This is especially important for the data clients who use historical data (recorded by them or purchased) for development and backtesting of automated strategies such as high frequency trading (HFT) from exchange co-located facilities. While on average such latency may be sub-millisecond, its peaks during bursts of market activity may reach dozens or even hundreds milliseconds, making the results of backtesting on such historical data unreliable.

Another positive consequence of the innovation is the simplicity due to unification of the rules, and the initial data processing component implemented by agents. For instance, in relation to trading venues the data processing algorithms may have higher complexity and require higher computation power than the algorithm of processing the actions, which is described by the rules. Moreover, different exchanges and intermediate data vendors may require different data processing algorithms, making it difficult for the data clients to handle the data from different sources or to switch between them. In practice, there are at least dozens of significantly different data processing algorithms.

At least some embodiments of the applicable systems may be very competitive, such as trading or gaming. In order to succeed, agents need to know as much as necessary about the current world, and be able to predict the future state of the world. But since the world state is driven by actions of agents (including agent's own actions), predicting its future state means knowing the current state and predicting the actions of other agents given agent's own actions. Since actions of agents may be logically ongoing process , they may better than anything else reflect their intentions, therefore future actions, and thus provide a better prediction.

Observing actions of agents directly (instead of observing resulting changes in the world state) may also serve as a news feed. In general, agents are not limited to the information they receive from the venue only. They may use external data sources as well. For instance, traders may analyse social media or subscribe to news feeds, dedicated to inform as soon as possible (sometimes within milliseconds) when anything happens that may affect the market they are trading. Such events don't affect the market directly. They affect the actions of traders which in turn affect the market. Thus, observing actions of agents can provide early alerts about relevant events. These qualities of the innovation can be best described as transparency.

The innovation provides maximum transparency because SOA can be converted into any other type of data feed, but the opposite is false.

Some single actions may instantly cause a large number of events and changes in the world state, for instance, a grenade in a shooter game or a large order executed against many small orders in trading. The innovation allows to transmit the single action itself instead of large number of consequent updates which either require a faster internet connection or adds latency.

The innovation offers most compact method of data transmission because any action of agents requires to transmit exactly one data update (the action itself) to the data clients.

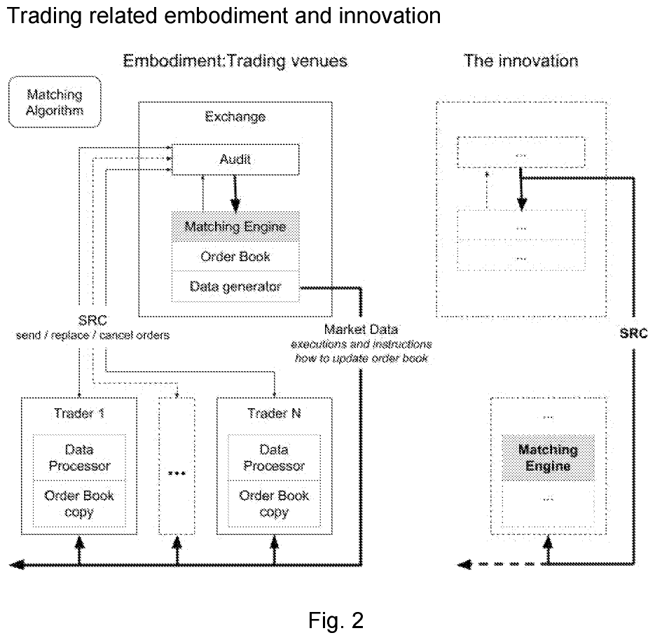

Attention is drawn to FIG. 2 illustrating a trading venue as one of the applicable systems, and the corresponding embodiments of the invention.

In the example here illustrated, terms applicable to a trading environment will first be associated to those already described herein above. The above discussed ‘venue’ in this embodiment corresponds to the ‘exchange’ or a trading venue in general. ‘Agents’ correspond to ‘traders’; ‘rules’ correspond to ‘matching algorithm’; ‘engine’ corresponds to ‘matching engine’; ‘world state’ corresponds to ‘order book’; ‘data’ corresponds to ‘market data’. In addition, the stream of actions ‘SOA’ corresponds to ‘SRC’, which is an abbreviation of the typical set of actions within trading venues: send, replace, cancel in relation to orders.

This embodiment in FIG. 2 shares the same qualities with the more generic example in FIG. 1, described above.

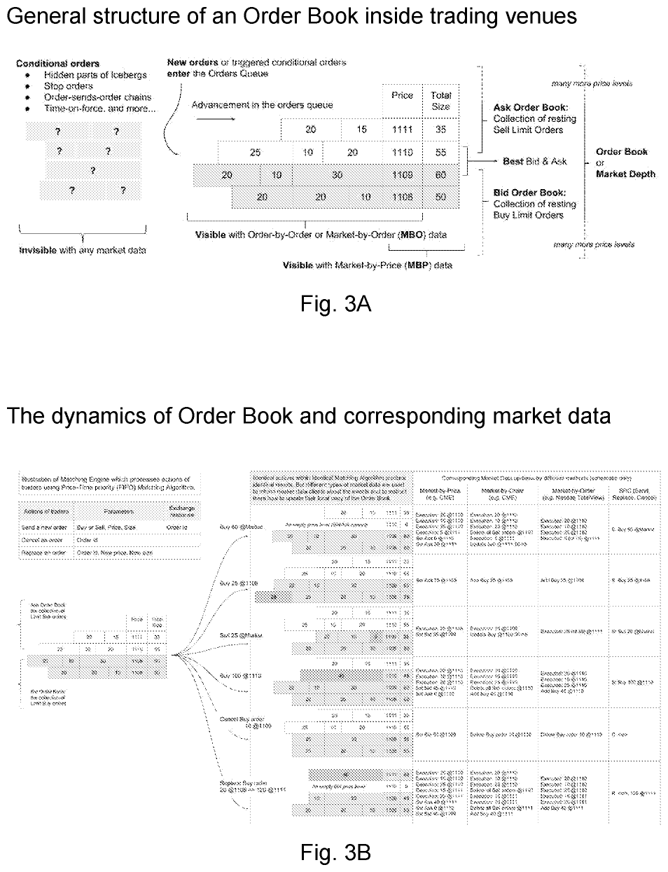

Attention is drawn to FIG. 3A illustrates the structure of a typical Order Book within trading venues. Order book is a collection of Limit orders of traders, constructed by matching engines of trading venues. These orders are resting in the Order book because their Limit price doesn't permit their execution. This is why the lowest Limit price all Sell orders is higher than the highest Limit price all Buy orders.

Trading venues may also manage invisible in market data conditional orders of traders. Such orders have a certain trigger or condition to be published and released after which they enter into the regular processing of orders.

The collection of orders at the same price level is called order queue. Orders can advance in the queue when other orders in front of them are canceled or executed/matched with new arriving orders. The arrangement of orders in the queue and the priority of their execution is determined by matching algorithms.

Attention is drawn to FIG. 3B illustrates actions of traders and how they are processed by Matching Engine using as an example Price-Time priority Matching Algorithm.

The drawing illustrates an example of an initial state of the Order book. In one of the examples that appear on top, a trader sends a new order to purchase 60 units at market price. According to Price-Time priority, this order is matched first with Sell orders at price 1110 according to their location in the order queue. Because the total size of all Sell orders at 1110 was 55, the Buy order was also matched at price 1111, making a partial execution of 5 units with a Sell order of size 15.

Columns on the right side show how the results of the action ‘Buy 60@Market’ are reported to data clients by different types of data feed. It's apparent that SRC method is more transparent and more compact.

It's apparent from other 5 examples that any other action of trades requires exactly one market data update using SRC while may require much more using other types of data.

In yet another example which isn't demonstrated in FIG. 3B, advantages of implementing embodiments of the invention to trading will be exemplified. Assume that the highest price of resting buy orders of a particular stock is 170.00. The price range between 170.00 and 169.95 inclusively contains 50 resting buy orders, and their total size is 9,000 shares. At this moment a trader sends a new limit sell order to sell 10,000 shares with limit price (i.e. not lower than) 169.95. The order is matched against all 50 buy orders between 170.00 and 169.95, starting from the highest price and according to the priority, described by the matching algorithm. The order cannot be executed further due to its limit price. The remaining unfilled part of the order is 1,000 and it enters the order book as a resting sell order at 169.95, creating a new best ask.

Conventional types of data feeds used by known trading venues (such as Nasdaq, NYSE, BATS, CME, Eurex, BM&FBovespa, etc.) require sending a long series of between 51 to 101 or more data updates to communicate the above trading event scenario to data clients. In some cases such series can be replaced by an aggregated update event affecting the transparency, but even aggregated update would consist of more than 1 data update. It's apparent that SRC method allows communicating such scenario to data clients within a single “S” data update in a form “S,Sell,10,000,169.95” or similar with maximum transparency.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood from the generic description of applicable systems illustrated in FIG. 1.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. An architecture for providing data clients with a raw data feed allowing to produce a locally made copy of a world evolving state of a multiagent interactive venue, comprising:
Wherein said raw data feed is the actions that being sent by agents to the venue, and
Wherein said venue processing said actions according to predefined rules defining how each of said actions affects the world state of the venue, and
Wherein said world state is the cumulative effect of actions of agents, applied on the initial world state, and
wherein the architecture providing said data feeds communicated to data clients, in the form of a stream as received by the venue, before being processed by the venue.

2. The architecture of claim 1 wherein the architecture further providing for changing the local copy of the world state, by applying predefined rules.

3. The architecture of claim 1 wherein actions are sent by agents to the venue asynchronously or synchronously and the data feed communicated to data clients synchronized by the venue upon arrival to the venue before being processed.

4. The architecture of claim 3, wherein synchronization is provided by tracking order of arrival of actions at the venue.

5. The architecture of claim 4, wherein the data feed is ordered according to the tracking.

6. The architecture of claim 4, wherein the data feed comprises the tracking information.

7. The architecture of claim 1, wherein the predefined rules applied for said data feeds communicated to said data clients change the local copy of the world state according to substantially the same predefined rules applied for changing the world state at the venue.

8. The architecture of claim 1, wherein the same predefined rules change the copy of the world state in exactly the same manner as they change the world state as reflected in the venue.

9. The architecture of claim 1, wherein the venue is a trading venue and the agents are traders interacting with the venue.

10. The architecture of claim 1, wherein data feeds communicated to data clients contains only valid actions.

11. A method for providing data clients with a raw data feed allowing to produce a local made copy of a world evolving state of a multiagent interactive venue, comprising:
Permitting communication of raw data to data clients and
providing for changing the local copy of the world state, by applying predefined rules,
Wherein said raw data feed is the actions that being sent by agents to the venue, and
Wherein said venue processing said actions according to predefined rules defining how each of said actions affects the world state of the venue, and
Wherein said world state is the cumulative effect of actions of agents, applied on the initial world state, and
Wherein said data feeds communicated to data clients, in the form of a stream as received by the venue, before being processed by the venue.

12. The method of claim 11, wherein actions are sent by agents asynchronously or asynchronously to the venue and the data feed communicated to data clients is synchronous.

13. The method of claim 12, wherein synchronization is provided by tracking order of arrival of actions at the venue.

14. The method of claim 12, wherein the data feed is ordered according to the tracking.

15. The method of claim 12, wherein the data feed comprises the tracking information.

16. The method of claim 1, wherein the data feeds communicated to data clients change the local copy of the world state according to the substantially same predefined rules applied for changing the world state at the venue.

17. The method of claim 11, wherein the same predefined rules change the copy of the world state in exactly the same manner as they change the world state as reflected in the venue.

18. The method of claim 1, wherein the venue if a trading venue and the agents are traders interacting with the venue.

19. The method of claim 1, wherein data feeds communicated to data clients contains only valid actions.
